(19) United States
(12) Patent Application Publication
(10) Pub. No.: US 2008/0107112 A1
(43) Pub. Date: May 8, 2008

(54) Network device and packet forwarding method thereof

(75) Inventors: Cheng-Chih Kuo, Tu-Cheng (TW); Shin-hsin Hsu, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: Hon Hai Precision Industry Co., LTD.

(21) Appl. No.: 11/648,016

(22) Filed: Dec. 29, 2006

(30) Foreign Application Priority Data
Nov. 3, 2006 (TW) 95140829

(51) Int. Cl. H04L 12/56

(52) U.S. Cl. 370/392; 370/401

(57) ABSTRACT

A network device connected to a client includes a table-creation module, a transceiving module, a detecting module, and a translation module. The table-creation module creates an internal table and at least one external table, listing a plurality of real network parameters of the network device, and a plurality of virtual network parameters of the network device, respectively. The real parameters respectively corresponding to the virtual parameters. The transceiving module receives a packet from the network or the client, and forwards the packet. The detecting module detects whether the packet is a voice over Internet protocol (VoIP) packet, and further detects whether the VoIP packet is a VoIP control packet, or a VoIP data packet. The translation module translates network parameters of the VoIP packet according to a corresponding relationship between the internal table and the at least one external table. A packet forwarding method is also provided.

### BACKGROUND OF THE INVENTION

1. Field of the Invention

The invention generally relates to wireless communication, and particularly to a network device and packet forwarding method thereof.

2. Description of Related Art

In a present voice over Internet protocol (VoIP) system, a VoIP gateway is an indispensable component that performs real-time compression and protocol translation of a packet from a VoIP phone or the Internet. When an enterprise expects to use a VoIP service, the enterprise needs to rent the VoIP gateway from a VoIP service provider (SP).

However, a problem with a traditional VoIP gateway is that each VoIP gateway may not be shared by more than one enterprise, even if an enterprise only expects to rent some ports of the VoIP gateway, the remaining ports can not be used by other enterprises. This is a waste of communication resources. Besides, some traditional VoIP gateways may have at least two virtual media gateways set therein to enhance use of the VoIP gateways and share resources of the gateways to others. Unfortunately, these VoIP gateways are not flexible enough to provide an adjustable number of virtual media gateways or manage these virtual media gateways according to actual need of users.

### SUMMARY OF THE INVENTION

A network device connected to a client is provided. The network device includes a table-creation module, a transceiving module, a detecting module, and a translation module. The table-creation module creates an internal table and at least one external table, the internal table listing a plurality of real network parameters of the network device, the at least one external table listing a plurality of virtual network parameters of the network device, and the real network parameters respectively corresponding to the virtual network parameters. The transceiving module receives a packet from the network or the client, and forwards the packet. The detecting module detects whether the packet is a voice over Internet protocol (VoIP) packet according to the internal table and the at least one external table, and further detects whether the VoIP packet is a VoIP control packet, or a VoIP data packet. The translation module translates network parameters of the VoIP packet according to a corresponding relationship between the internal table and the at least one external table if the VoIP packet is the VoIP control packet.

A packet forwarding method applicable to a network device connected between a client and a network is also provided. The packet forwarding method includes: creating an internal table and at least one external table, the internal table listing a plurality of real network parameters of the network device, the at least one external table listing a plurality of virtual network parameters of the network device, and the real network parameters respectively corresponding to the virtual network parameters; receiving a packet from the network; detecting whether the packet is a voice over Internet protocol (VoIP) packet according to the internal table and the at least one external table; detecting whether the VoIP packet is a VoIP control packet or a VoIP data packet if the packet is the VoIP packet; translating virtual network parameters of the VoIP packet according to a corresponding relationship between the internal table and the at least one external table if the VoIP packet is the VoIP control packet; and forwarding the VoIP control packet to the client according to translated virtual network parameters thereof.

Another packet forwarding method applicable to a network device connected between a client and a network is further provided, the packet forwarding method comprising: creating an internal table and at least one external table, the internal table listing a plurality of real network parameters of the network device, the at least one external table listing a plurality of virtual network parameters of the network device, and the real network parameters respectively corresponding to the virtual network parameters; receiving a packet from the client; detecting whether the packet is a VoIP control packet or a VoIP data packet according to the internal table and the at least one external table; translating real network parameters of the VoIP control packet according to a corresponding relationship between the internal table and the at least one external table if the packet is the VoIP control packet; translating real network parameters of the VoIP control packet or the VoIP data packet according to the corresponding relationship between the internal table and the at least one external table; and forwarding the VoIP control packet or the VoIP data packet to the network according to translated real network parameters thereof.

Other advantages and novel features will become more apparent from the following detailed description when taken in conjunction with the accompanying drawings, in which:

### BRIEF DESCRIPTION OF THE DRAWINGS

FIG. 1 is a diagram illustrating an application environment of a network device of an exemplary embodiment of the invention;

FIG. 2 is a block diagram of the network device of an exemplary embodiment of the invention;

FIG. 3 is a diagram illustrating an internal table and at least one external table of the invention;

FIG. 4 is a flowchart of a packet forwarding method of another exemplary embodiment of the invention; and

FIG. 5 is a flowchart of another packet forwarding method of a further exemplary embodiment of the invention.

### DETAILED DESCRIPTION OF THE INVENTION

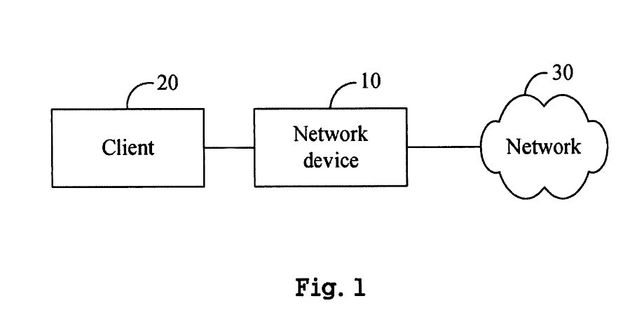

FIG. 1 is a diagram illustrating an application environment of a network device 10 of an exemplary embodiment of the invention.

The network device 10 is connected between a client 20 and a network 30, for forwarding a packet therebetween. Packet types include a control packet and a data packet. In this embodiment, the network device 10 is a voice over Internet protocol (VoIP) gateway, the client 20 is a VoIP phone, the network 30 is the Internet, the control packet is a media gateway control protocol (MGCP) packet for carrying control signaling, and the data packet is a real-time transmission protocol (RTP) packet for carrying voice data.

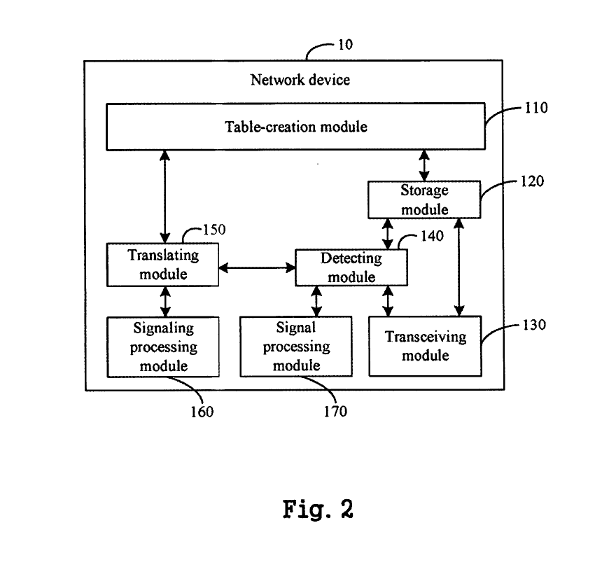

FIG. 2 is a block diagram of the network device 10 of an exemplary embodiment of the invention.

The network device 10 includes a table-creation module 110, a storage module 120, a transceiving module 130, a detecting module 140, a translation module 150, a signaling processing module 160, and a signal processing module 170.

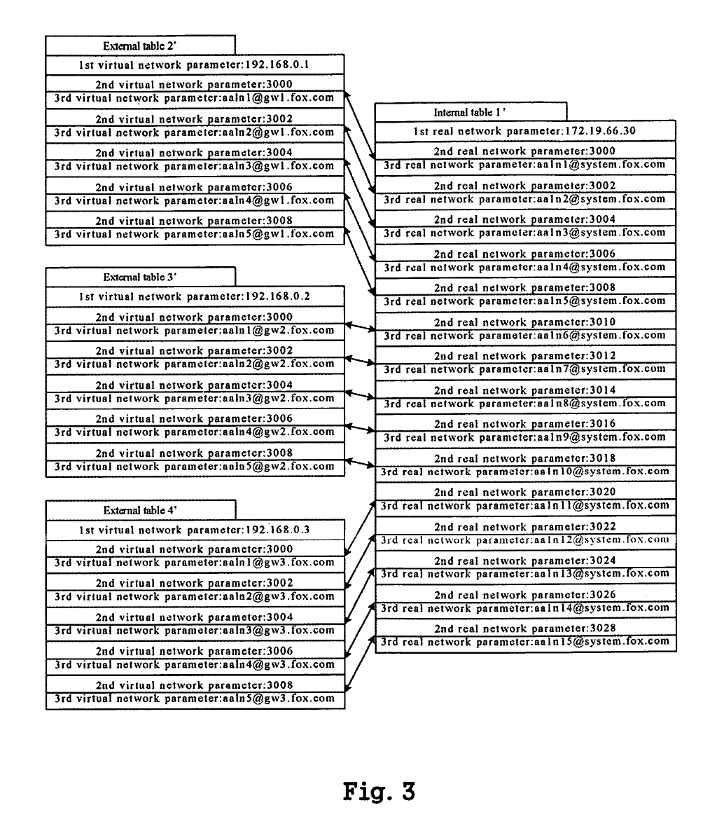

The table-creation module 110 creates an internal table and at least one external table, the internal table listing a plurality of real network parameters of the network device 1 0, the at least one external table listing a plurality of virtual network parameters of the network device 10, and the real network parameters respectively corresponding to the virtual network parameters. Now referring to FIG. 3, a diagram illustrating the internal table and the at least one external table of the invention is shown.

As shown in FIG. 3, an internal table 1′ includes a first real network parameter field, a plurality of second real network parameter fields and a plurality of third real network parameter fields. In this embodiment, the first real network parameter, the second real network parameter, and the third real network parameter respectively represent a real Internet protocol (IP) address, a real port number, and a real endpoint name of the network device 10. As can be seen from FIG. 3, a real IP address of the network device 10 is 172.19.66.30, real port numbers thereof include 3000, 3002, . . . , and 3028, and real endpoint names thereof include aaln1@system.fox.com, aaln2@system.fox.com, . . . , and aaln15@system.fox.com.

As shown in FIG. 3, three external tables 2′, 3′ and 4′ all include a first virtual network parameter field, a plurality of second virtual network parameter fields, and a plurality of third virtual network parameter fields. In this embodiment, the first virtual network parameter, the second virtual network parameter, and the third virtual network parameter are respectively a virtual Internet protocol (IP) address, a virtual port number, and a virtual endpoint name of the network device 10.

In the external table 2′, the virtual IP address of the network device 10 is 192.168.0.1, the virtual port numbers thereof include 3000, 3002, . . . , 3008, and the virtual endpoint names thereof include aaln1@gw1.fox.com, aaln2@gw1.fox.com, . . . , and aaln5@gw1.fox.com. The virtual endpoint names aaln1@gw1.fox.com, aaln2@gw1.fox.com, . . . , and aaln5@gw1.fox.com respectively correspond to the real end point names aaln1@system.fox.com, aaln2@system.fox.com, . . . , and aaln5@system.fox.com in the external table 1′.

In the external table 3′, the virtual IP address of the network device 10 is 192.168.0.2, the virtual port numbers thereof include 3000, 3002, . . . , 3008, and the virtual endpoint names thereof include aaln1@gw2.fox.com, aaln2@gw2.fox.com, . . . , and aaln5@gw2.fox.com. The virtual port numbers 3000, 3002, . . . , and 3008 respectively correspond to the real port numbers 3010, 3012, . . . , and 3018 in the external table 1′, and the virtual endpoint names aaln1@gw2.fox.com, aaln2@gw2.fox.com, . . . , and aaln5@gw2.fox.com respectively correspond to the real end point names aaln6@system.fox.com, aaln7@system.fox.com, . . . , and aaln10@system.fox.com in the external table 1′.

In the external table 4′, the virtual IP address of the network device 10 is 192.168.0.3, the virtual port numbers thereof include 3000, 3002, . . . , and 3008, and the virtual endpoint names thereof include aaln1@gw3.fox.com, aaln2@gw3.fox.com, . . . , and aaln5@gw3.fox.com. The virtual port numbers 3000, 3002, . . . , 3008 respectively correspond to the real port numbers 3020, 3012, . . . , and 3028 in the external table 1′, and the virtual endpoint names aaln1@gw3.fox.com, aaln2@gw3.fox.com, . . . , and aaln5@gw3.fox.com respectively correspond to the real end point names aaln11@system.fox.com, aaln12@system.fox.com, . . . , and aaln15@system.fox.com in the external table 1′.

The storage module 120 stores the internal table and the at least one external table. In this embodiment, the storage module 120 may be a random access memory (RAM) or a flash memory.

The transceiving module 130 receives a packet from one of the client 20 and the network 30, and transmits the packet to the other one of the client 20 and network 30. In this embodiment, the transceiving module 130 may be a network card or a subscriber line interface circuit (SLIC). In this embodiment, the packet has a first network parameter, a second network parameter, and a third network parameter, which respectively represent a destination IP address, a destination port number, and a destination endpoint name indicated in a header field of the packet.

The detecting module 140 detects whether the packet is a voice over Internet protocol (VoIP) packet according to the internal table and the at least one external table. In detail, the detecting module 140 firstly checks the header field of the packet for the destination IP address and the destination port number thereof, and then detects whether the destination IP address and the destination port number are already listed in the internal table and the at least one external table. If the destination IP address and the destination port number are already listed in the internal table and the at least one external table, the packet is a VoIP packet, otherwise the packet is not a VoIP packet.

The detecting module 140 further translates the first network parameter and the second network parameter of the packet if the packet is the VoIP packet. In detail, if the packet is received from the network 30, the detecting module 140 checks the at least one external table for the virtual IP address and the virtual port number according to the destination IP address and the destination port number, then checks the internal table for the real IP address and the real port number respectively corresponding to the virtual IP address and the virtual port number, and translates the destination IP address and the destination port number according to the real IP address and the real port number. If the packet is received from the client 20, the detecting module 140 checks the internal table for the real IP address and the real port number according to the destination IP address and the destination port number, then checks the at least one external table for the virtual IP address and the virtual port number respectively corresponding to the real IP address and the real port number, and translates the destination IP address and the destination port number according to the virtual IP address and the virtual port number.

The detecting module 140 still further detects whether the VoIP packet is a VoIP control packet or a VoIP data packet. In detail, the detecting module 140 detects whether the packet is a VoIP control packet or a VoIP data packet by checking the header field of the packet. In this embodiment, if the destination port number indicated in the header field is 2427, the packet is a VoIP control packet, otherwise the packet is a VoIP data packet.

The translation module 150 translates the third network parameter of the packet according to a corresponding relationship between the internal table and the at least one external table if the packet is a VoIP control packet. In detail, if the packet is received from the network 30, the translation module 150 checks the at least one external table for the virtual endpoint name according to the destination endpoint name indicated in the header field of the packet, then checks the internal table for the real endpoint name corresponding to the virtual endpoint name, and translates the destination endpoint name according to the real endpoint name. If the packet is received from the client 30, the translation module 150 checks the internal table for the real endpoint name according to the destination endpoint name indicated in the header field of the packet, then checks the at least one external table for the virtual endpoint name corresponding to the real endpoint name, and translates the destination endpoint name according to the virtual endpoint name.

The signaling processing module 180 performs signaling operations of the VoIP control packet. In this embodiment, the signaling processing module 180 is a MGCP processor.

The signal processing module 170 performs digital signal processing of the VoIP data packet. In this embodiment, the signal processing module 170 is a digital signal processor (DSP).

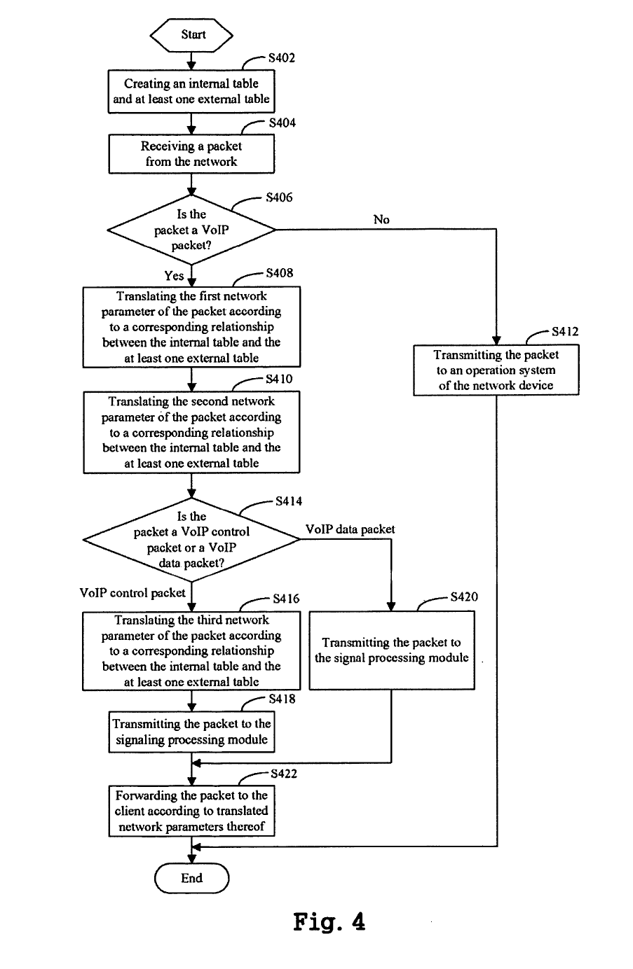

FIG. 4 is a flowchart of a packet forwarding method of another exemplary embodiment of the invention.

In step S402, the table-creation module 110 creates an internal table and at least one external table, the internal table listing a plurality of real network parameters of the network device 10, the at least one external table listing a plurality of virtual network parameters of the network device 10, and the real network parameters respectively corresponding to the virtual network parameters.

As shown in FIG. 3, the table-creation module 110 firstly creates an internal table 1′.

Secondly, the table-creation module 110 adds a first real network parameter of the network device 10 to the internal table 1′. In this embodiment, the first real network parameter is a real Internet protocol (IP) address. As can be seen from FIG. 3, the real IP address added by the table-creation module 110 is 172.19.66.30.

Thirdly, the table-creation module 110 adds a plurality of second real network parameters of the network device 10 to the internal table 1′. In this embodiment, the second real network parameter is a real port number. As can be seen from FIG. 3, the real port numbers added by the table-creation module 110 are 3000, 3002, . . . , and 3028.

Fourthly, the table-creation module 110 adds a plurality of third real network parameters of the network device 10 to the internal table 1′. In this embodiment, the third real network parameter is a real endpoint name. As can be seen from FIG. 3, the real endpoint names added by the table-creation module 110 are aaln1@system.fox.com, aaln2@system.fox.com, . . . , and aaln15@system.fox.com.

Fifthly, the table-creation module 110 creates at least one external table. As can be seen from FIG. 3, the table-creation module 110 creates three external tables 2′, 3′ and 4′.

Sixthly, the table-creation module 110 adds a plurality of first virtual network parameters of the network device 10 to the at least one external table. In this embodiment, the first virtual network parameter is a virtual IP address. As can be seen from FIG. 3, the virtual IP addresses added by the table-creation module 110 to the external table 2′ is 192.168.0.1, to the external table 3′ is 192.168.0.2, and to the external table 4′ is 192.168.0.3.

Seventhly, the table-creation module 110 adds a plurality of second virtual network parameters of the network device 10 to the at least one external table. In this embodiment, the second virtual network parameter is a virtual port number. As can be seen from FIG. 3, the virtual port numbers added by the table-creation module 110 to the external tables 2′, 3′ and 4′ are all 3000, 3002, . . . , 3008.

Eighthly, the table-creation module 110 adds a plurality of third virtual network parameters of the network device 10 to the at least one external table. In this embodiment, the third virtual network parameter is a virtual endpoint name. As can be seen from FIG. 3, the virtual endpoint names added by the table-creation module 110 to the external table 2′ are aaln1@gw1.fox.com, aaln2@gw1.fox.com, . . . , and aaln5@gw1.fox.com, to the external table 3′ are aaln1@gw2.fox.com, aaln2@gw2.fox.com, . . . , and aaln5@gw2.fox.com, and to the external table 4′ are aaln1@gw3.fox.com, aaln2@gw3.fox.com, . . . , and aaln5@gw3.fox.com.

In step S404, the transceiving module 120 receives a packet from the network 30. In this embodiment, the packet has a first network parameter, a second network parameter and a third network parameter, which respectively represent a destination IP address, a destination port number and a destination endpoint name indicated in a header field of the packet.

In step S406, the detecting module 140 detects whether the packet is a voice over Internet protocol (VoIP) packet according to the internal table and the at least one external table. In detail, the detecting module 140 firstly checks the header field of the packet for the destination IP address and the destination port number thereof, and then detects whether the destination IP address and the destination port number are already listed in the internal table and the at least one external table. If the destination IP address and the destination port number are already listed in the internal table and the at least one external table, the packet is a VoIP packet, otherwise the packet is not a VoIP packet. If the packet is a VoIP packet, the process proceeds to step S408, otherwise the process proceeds to step S412.

In step S408, the detecting module 140 translates the first network parameter of the VoIP packet according to a corresponding relationship between the internal table and the at least one external table. In detail, the detecting module 1 40 checks the at least one external table for the virtual IP address according to the destination IP address, then checks the internal table for the real IP address corresponding to the virtual IP address, and translates the destination IP address according to the real IP address.

In step S410, the detecting module 140 translates the second network parameter of the VoIP packet according to a corresponding relationship between the internal table and the at least one external table. In detail, the detecting module 140 checks the at least one external table for the virtual port number according to the destination port number, then checks the internal table for the real port number corresponding to the virtual port number, and translates the destination port number according to the real IP address.

In step S412, the detecting module 140 transmits the packet to an operation system in the network device 10 for further processing.

In step S414, the detecting module 140 detects whether the packet is a VoIP control packet or a VoIP data packet. In detail, the detecting module 140 detects whether the packet is a VoIP control packet or a VoIP data packet by checking the header field of the packet. If the destination port number indicated in the header field is 2427, the packet is the VoIP control packet, otherwise the packet is the VoIP data packet. If the packet is the VoIP control packet, the process proceeds to step S416, otherwise the process proceeds to step S420.

In step S416, the translation module 150 translates the third network parameter of the packet according to a corresponding relationship between the internal table and the at least one external table. In detail, the translation module 150 checks the at least one external table for the virtual endpoint name according to the destination endpoint name indicated in the header field of the packet, then checks the internal table for the real endpoint name corresponding to the virtual endpoint name, and translates the destination endpoint name according to the real endpoint name.

In step S418, the translation module 150 transmits the packet to the signaling processing module 160 for performing signaling operation thereon.

In step S420, the translation module 150 transmits the packet to the signal processing module 160 for performing digital signal processing thereon.

In step S422, the transceiving module 130 forwards the packet to the client 30 according to translated network parameters thereof.

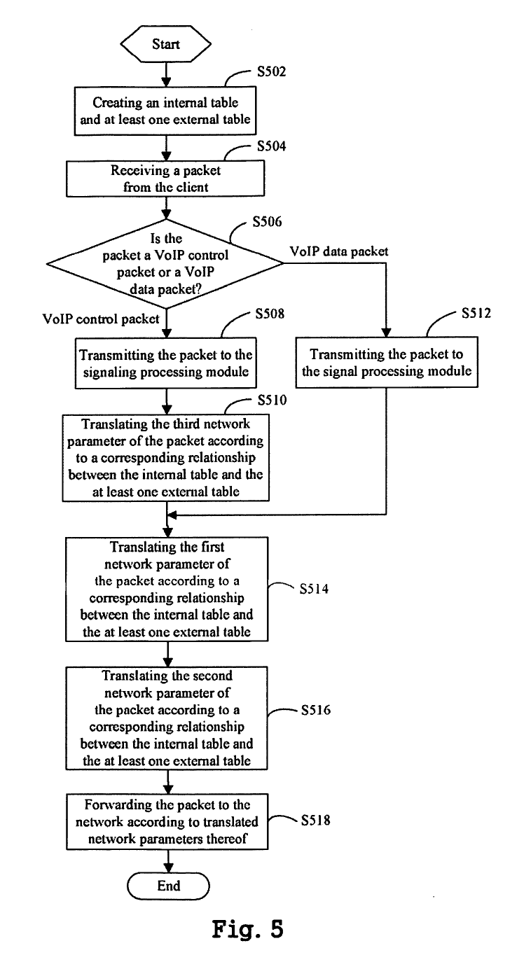

FIG. 5 is a flowchart of another packet forwarding method of a further exemplary embodiment of the invention.

In step S502, the table-creation module 110 creates an internal table and at least one external table, the internal table listing a plurality of real network parameters of the network device 10, the at least one external table listing a plurality of virtual network parameters of the network device 10, and the real network parameters respectively corresponding to the virtual network parameters. In this embodiment, steps of creating the internal table and the at least one external table are the same as those described with regard to FIG. 5, and will not be repeated herein.

In step S504, the transceiving module 120 receives a packet from the client 20. In this embodiment, the packet has a first network parameter, a second network parameter, and a third network parameter, which respectively represent a destination IP address, a destination port number and a destination endpoint name indicated in a header field of the packet.

In step S506, the detecting module 140 detects whether the packet is a VoIP control packet or a VoIP data packet. In detail, the detecting module 140 detects whether the packet is a VoIP control packet or a VoIP data packet by checking the header field of the packet. If the destination port number indicated in the header field is 2427, the packet is the VoIP control packet, otherwise the packet is the VoIP data packet. If the packet is the VoIP control packet, the process proceeds to step S508, otherwise the process proceeds to step S512.

In step S508, the translation module 150 transmits the packet to the signaling processing module 160 for performing signaling operation thereon.

In step S510, the translation module 150 translates the third network parameter of the packet according to a corresponding relationship between the internal table and the at least one external table. In detail, the translation module 150 checks the internal table for the real endpoint name according to the destination endpoint name indicated in the header field of the packet, then checks the at least one external table for the virtual endpoint name corresponding to the real endpoint name, and translates the destination endpoint name according to the virtual endpoint name.

In step S512, the translation module 150 transmits the packet to the signal processing module 160 for performing digital signal processing thereon.

In step S514, the detecting module 140 translates the first network parameter of the packet according to a corresponding relationship between the internal table and the at least one external table. In detail, the detecting module 140 checks the internal table for the real IP address according to the destination IP address, then checks the at least one external table for the virtual IP address corresponding to the real IP address, and translates the destination IP address according to the virtual IP address.

In step S516, the detecting module 140 translates the second network parameter of the packet according to a corresponding relationship between the internal table and the at least one external table. In detail, the detecting module 140 checks the internal table for the real port number according to the destination port number, then checks the at least one external table for the virtual port number corresponding to the real IP address, and translates the destination port number according to the virtual IP address.

In step S518, the transceiving module 130 forwards the packet to the network 20 according to translated network parameters thereof.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A network device connected to a client, comprising:
a table-creation module for creating an internal table and at least one external table, the internal table listing a plurality of real network parameters of the network device, the at least one external table listing a plurality of virtual network parameters of the network device, and the real network parameters respectively corresponding to the virtual network parameters;
a transceiving module for receiving a packet from one of a network and the client, and for forwarding the packet to the other one of the network and the client;
a detecting module for detecting whether the packet is a voice over Internet protocol (VoIP) packet according to the internal table and the at least one external table, and for further detecting whether the VoIP packet is a VoIP control packet, or a VoIP data packet; and
a translation module for translating network parameters of the VoIP packet according to a corresponding relationship between the internal table and the at least one external table if the VoIP packet is a VoIP control packet.

2. The network device in accordance with claim 1, wherein the real network parameters comprise a first real network parameter, a plurality of second real network parameters, and a plurality of third real network parameters, which respectively represent a real Internet protocol (IP) address, a plurality of real port numbers, and a plurality of real endpoint names.

3. The network device in accordance with claim 1, wherein the virtual network parameters comprise a plurality of first virtual network parameters, a plurality of second virtual network parameters and a plurality of third virtual network parameters, which respectively represent a plurality of virtual IP addresses, a plurality of virtual port numbers and a plurality of virtual endpoint names.

4. The network device in accordance with claim 1, wherein the network parameters comprise a first network parameter, a second network parameter and a third network parameter, which respectively represent a destination IP address, a destination port number and a destination endpoint name indicated in a header field of the packet.

5. The network device in accordance with claim 4, wherein the translation module is further for translating the third network parameter according to the corresponding relationship between the internal table and the at least one external table.

6. The network device in accordance with claim 5, wherein the detecting module is further for translating the first network parameter and the second network parameter if the packet is the VoIP packet.

7. The network device in accordance with claim 1, further comprising:
a signaling processing module for processing the packet translated by the translation module; and
a signal processing module for processing the VoIP packet if the VoIP packet is a VoIP data packet.

8. A packet forwarding method applicable to a network device connected between a client and a network, comprising:
creating an internal table and at least one external table, the internal table listing a plurality of real network parameters of the network device, the at least one external table listing a plurality of virtual network parameters of the network device, and the real network parameters respectively corresponding to the virtual network parameters;
receiving a packet from one of a client and a network;
translating network parameters of the packet according to a corresponding relationship between the internal table and the at least one external table; and
forwarding the packet to the other of the client and the network according to the translated network parameters thereof.

9. The packet forwarding method in accordance with claim 8, wherein the real network parameters comprise a first real network parameter, a plurality of second real network parameters and a plurality of third real network parameters, which respectively represent a real Internet protocol (IP) address, a plurality of real port numbers and a plurality of real endpoint names.

10. The packet forwarding method in accordance with claim 8, wherein the virtual network parameters comprise a plurality of first virtual network parameters, a plurality of second virtual network parameters and a plurality of third virtual network parameters, which respectively represent a plurality of virtual IP addresses, a plurality of virtual port numbers, and a plurality of virtual endpoint names.

11. The packet forwarding method in accordance with claim 8, further comprising detecting whether the packet is a voice over Internet protocol (VoIP) control packet or a VoIP data packet according to the internal table and the at least one external table;

12. The packet forwarding method in accordance with claim 11, wherein the network parameters of the packet comprise a first network parameter, a second network parameter, and a third network parameter, which respectively represent a destination IP address, a destination port number, and a destination endpoint name indicated in a header field of the packet.

13. The packet forwarding method in accordance with claim 12, further comprising translating the first network parameter and the second network parameter according to the corresponding relationship between the internal table and the at least one external table if the packet is a VoIP packet including the VoIP control packet and the VoIP data packet.

14. The packet forwarding method in accordance with claim 13, wherein the step of translating the first network parameter and the second network parameter according to the corresponding relationship between the internal table and the at least one external table if the packet is the VoIP packet further comprises:
checking one of the at least one external table and the internal table for one of a first virtual network parameter out of the at least one external table and a first real network parameter out of the internal table, and for one of a second virtual network parameter out of the at least one external table and a second real network parameter out of the internal table according to the first network parameter and the second network parameter of the packet;
checking the other of the at least one external table and the internal table for the corresponding other of the first virtual network parameter out of the at least one external table and the first real network parameter out of the internal table, and for the corresponding other of the second virtual network parameter out of the at least one external table and the second real network parameter out of the internal table respectively according to the one of the first real and virtual network parameters and the one of the second real and virtual network parameters; and
translating the first network parameter and the second network parameter according to the corresponding other of the first real and virtual network parameters and the corresponding other of the second real and virtual network parameters, respectively.

15. The packet forwarding method in accordance with claim 12, further comprising translating the third network parameter of the packet according to the corresponding relationship between the internal table and the at least one external table if the packet is the VoIP control packet.

16. The packet forwarding method in accordance with claim 15, wherein the step of translating the third network parameter of the VoIP control packet according to a corresponding relationship between the internal table and the at least one external table if the packet is the VoIP control packet comprises:
checking one of the at least one external table and the internal table for one of a third virtual network parameter out of the at least one external table and a third real network parameter out of the internal table according to the third network parameter of the packet;
checking the other of the at least one external table and the internal table for the corresponding other of the third virtual network parameter out of the at least one external table and the third real network parameter out of the internal table according to the one of the third real and virtual network parameters; and
translating the third network parameter of the packet according to the corresponding other of the third real and virtual network parameters.

17. A method for forwarding packets by a network device which is data-communicable between a client and a network, comprising steps of:
creating an internal table and at least one external table in a network device which is data-communicable between a client and a network, wherein said internal table lists a plurality of real network parameters of said network device used to data-communicate with said network, and said at least one external table lists a plurality of virtual network parameters of said network device respectively corresponding to said plurality of virtual network parameters and used to data-communicate with said client;
receiving a packet from one of said client and said network;
translating network parameters of said packet according to a corresponding relationship between said plurality of real network parameters of said internal table and said plurality of virtual network parameters of said at least one external table; and
forwarding said packet to the other of said client and said network according to said translated network parameters thereof.

18. The method in accordance with claim 17, wherein said network parameters of said packet comprise a first network parameter and a second network parameter used for a voice over Internet protocol (VoIP) packet when said packet is identified as said VoIP packet, and a third network parameter used for a VoIP control packet included by said VoIP packet when said packet is further identified as said VoIP control packet.
